(19) United States
(12) Patent Application Publication
(10) Pub. No.: US 2010/0306974 A1
(43) Pub. Date: Dec. 9, 2010

(54) Safety Double Connector

(76) Inventor: Evaristo Munoz Munoz, Mairena Del Alcor (ES)

Correspondence Address: John Alumit, 16830 Ventura Blvd. Suite 360, Encino, CA, 91436, US

(21) Appl. No.: 12/621,227

(22) Filed: Nov. 18, 2009

(30) Foreign Application Priority Data
Jun. 3, 2009 (ES) P200.901.351

(51) Int. Cl. F16B 45/00

(52) U.S. Cl. 24/598.8; 24/598.4; 24/598.7

(57) ABSTRACT

A safety double connector comprising a curved main frame forming the shape of a capital letter “S”. A closing element joins the start of the top end of the frame with a point on its body. Another closing element goes from the other end of the frame and also ends at a point on its body. The ends of the frame end in two notches or stops. The closing elements may be folded back easily by applying slight pressure so as to open the spaces between the body of the frame and the threads so as to enable an item to enter. These closing elements return to their initial position by means of a spring so as to close the space.

### CROSS-REFERENCE TO RELATED APPLICATION

This application claims the benefit of the priority filing date of Spanish Patent Application No. P200.901.351 filed on Jun. 3, 2009.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The double safety connector with which this present invention is concerned consists of a frame with at least two main curves, giving it an appearance similar to that of a capital letter “S”. At least two foldable elements are attached to this main frame which return to their position, opening and closing two spaces to allow an object or objects to pass into the interior of the space. These elements go from each end of the frame to its intermediate zone and include cantilever supports incorporated in the main frame in order to reinforce the opening and closing action. The shape may be symmetrical or asymmetrical according to the needs of the application. This enables a double connector to be obtained which offers full safety, given that two concatenated parts are used rather than one single part.

In the workplace or in sports such as mountaineering, or in activities such as the rescue or evacuation of civilians or military personnel, basic safety solutions are required which help employees and sportspeople to eliminate risks. In both cases it is essential to anchor a human body to a secure point. Safety is a fundamental issue in a wide range of industries and occupations.

This invention is set in the context of manufacturing devices for anchoring objects with a high level of safety.

There is currently a wide variety of secure attachment devices on the market, including shackles, karabiners, rings, eyes and hooks. In the construction industry, harnesses are used. Secure fastenings for hooks also exist. Document 282752 describes a type of hook in the form of a plastic loop with two types of openings for the respective eyes. Document 2133252 describes a safety hook which includes an opening through which a closing pin passes. Document 2166002 describes a hook with a side opening which is closed by a pin-shaped tongue.

However, all the known devices suffer from the following drawbacks:
Commercially available rings, eyes and hooks do not provide safety, given that their conventional design leaves open the space where objects are hung, making it possible for the object to slide free.
Harnesses are used in construction and sports involving heights, and comprise attachment devices, but use conventional fastenings described in the previous section.
Safety fastenings for hooks are attached once the hook has been attached to the object, and are attached separately, making it possible to use them under normal circumstances, but not where objects are raised to a height, or where people are moving at a height, above the ground, where greater speed and effectiveness of the hook closing is needed.
Document 282752 describes a hook which is in reality a connecting loop, but which has to be made from plastic in order to be attached to another device, which makes this form of fastening insecure given the ease with which the material may break if insufficient care is taken with the weight supported.
Document 2133252 describes a hook with a key fastening which closes the conventional hook by pressure and does not allow the attached object to escape from the enclosed interior of the hook by preventing it from sliding. However, this anti-slip solution makes it difficult to perform the reverse operation in order to release the object from the hook.
Document 2166002 describes a hook with a similar solution to that previously described, but in this case the fastening is in the form of a clip. This is suitable for marine use, as it has the same body as a normal hook where the interior holds the object to be held, but there is no fixing element, making it unsuitable for applications at height.

The invention described here offers the following advantages:
It is not designed in the conventional “C” shape but has at least two main curves giving it a shape like that of a capital letter “S”. This makes it much easier to close the spaces in which the object or objects to be attached are inserted.
It is not a harness structure, but a harness may include it in its attachments.
The safety fastening is included in the hook so it is not necessary to subsequently waste time attaching it, with the risk of the loss of balance when working at heights.
Its strength depends on the objects to be attached, given that it can be built from whatever material is most suitable.
It enables rapid attachment and release of the object held.
Its design does not include just one opening in the form of a “C” but takes the form of a capital letter “S”, giving greater safety as the operator can manipulate one opening while remaining attached to a secure point by the other opening.

Thus, this invention comprises a main frame in the form of a curve, with at least two main curves, giving it a shape similar to a capital letter “S”. A closing element joins the start of the top end of the frame with a point on its body. Another closing element goes from the other end of the frame and also ends at a point on its body. The ends of the frame end with a pair of notches or stops where the ends of the two closing elements are housed, attached by their ends to two points on the frame body. The fact that the notches are made at the ends of the frame will depend on the mechanical loading to which the frame is subjected. The closing elements are supported on brackets incorporated in the main frame in order to reinforce the opening and closing action. The closing elements have a safety thread which may be automatic, half-threaded or conventionally threaded. This thread needs to be displaced easily and, by applying slight pressure, to open the spaces between the body of the frame and the threads so as to enable an element to enter the space. The same closing elements are sprung-loaded so as to return to their original position, closing the space and thus preventing the element inserted in it from sliding out. To remove the element the user must press the closing fastening to fold it back and thereby release the element held. This means that the user is attached to a secure point by one of the spaces and can use the other space to attach the end of the element to which he wishes to attach himself with complete peace of mind. The frame has a strong dynamic effect as it is based on spring theory. Its design is inspired by studies of traction/compression equilibrium states, highlighting the elastic component of the way the frame works.

The design of the frame arises from searching for various fundamental objectives, including fatigue resistance, the dynamic effect of the actions performed, and elastic capacity.

In an alternative embodiment, the frame is made of a material suited to loading on each section of the frame, such that the main section of the frame is variable, although it can also be made with a continuous section.

In another alternative embodiment, the closing elements are made out of materials suited to load on them, such that they may be conventional trigger-type catches similar to those commercially available, lugs, including the safety variety, forks, clevises or pin-type elements that pass through the main frame, or the notches in it.

### SUMMARY

A Double safety connector comprising a curved main frame forming the shape of a capital letter “S”. A closing element joins the start of the top end of the frame with a point on its body. Another closing element goes from the other end of the frame and also ends at a point on its body. The ends of the frame end in two notches or stops. The closing elements may be folded back easily by applying slight pressure so as to open the spaces between the body of the frame and the threads so as to enable an item to enter. These closing elements return to their initial position by means of a spring so as to close the space.

### FIGURES

FIG. 1.—Front elevation of the connector

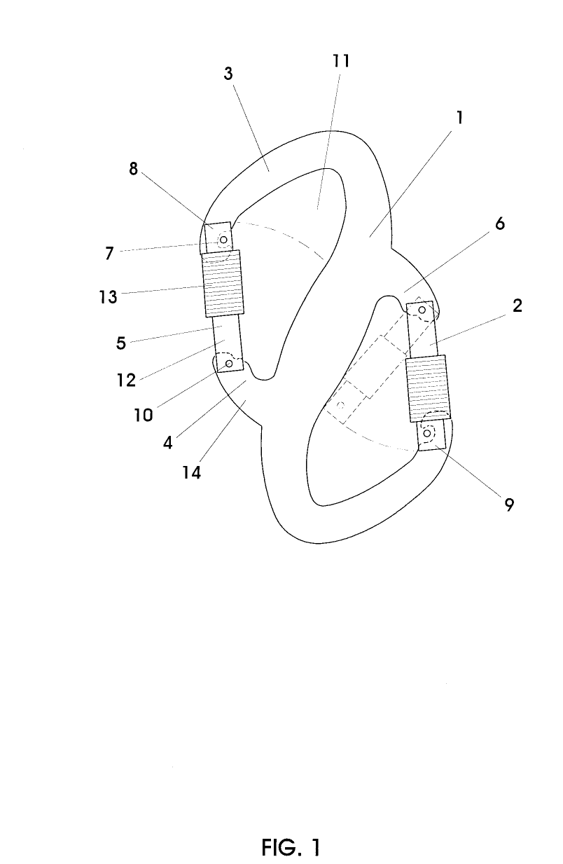

The numbered parts are:
1) Curved main frame.
2) Closing element.
3) Top end of frame body.
4) A point on the frame body.
5) Other closing element.
6) Other end of the frame.
7) Notches or stops
8) Ends of the closing parts.
9) Other ends of the closing parts.
10) Points on the frame body.
11) Spaces.
12) Spring.
13) Thread.
14) Brackets.

### DESCRIPTION

The preferred embodiment comprises a main frame in the form of a curve (1), with at least two main curves, giving it a shape similar to a capital letter “S”. A closing element (2) joins the start of the top end of the body (3) of the frame (1) with a point (4) on its body. Another closing element (5) goes from the other end of the frame (6) and also ends at a point on its body (4). The ends of the frame (3 and 6) end in a pair of notches or stops (7) where the ends (8) of the two closing elements (2 and 5) are housed, attached by their ends (9) to two points on the frame body (10). The closing elements (2 and 5) are supported on brackets (14) incorporated in the frame (1) in order to reinforce the opening and closing action. The closing elements (2 and 5) have a safety thread (13) which may be automatic, half-threaded or conventionally threaded. This thread (13) needs to be moved in order to fold back the closing elements (2 and 5) easily, and by applying slight pressure it opens the spaces (11) originated between the body (10) of the frame and these spaces (2 and 5) enabling an element to be inserted. By means of a spring (12) these closing elements (2 and 5) return to their initial position so as to close the space (11). To remove the element held inside the space (11) the user has to press the corresponding closing elements (2 and 5) to fold them back once the thread has been released.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A Safety double connector comprising a main frame in the form of a curve with at least two main curves, giving it a shape similar to a capital letter “S”.

2. The Safety double connector of claim 1, characterised by having a closing element which joins the start of the top end of the body of the frame with a point on its body.

3. The Safety double connector of claim 2, characterised by having another closing element at the other end of the frame which also ends at a point on its body.

4. The Safety double connector of claim 3, characterised by the fact that the ends of the frame end in a pair of notches or stops where the ends of the two closing elements are housed, attached by their ends to two points on the body of the frame.

5. The Safety double connector of claim 2, characterised by the fact that the closing elements are supported on brackets incorporated in the frame in order to reinforce the opening and closing action.

6. The Safety double connector of claim 2, characterised by the fact that the closing elements have a safety thread, which may be automatic, half threaded or conventionally threaded.

7. The Safety double connector of claim 2, characterised by the fact that the closing elements are made out of materials suited to the load on them, such that they may be conventional trigger-type catches, similar to those commercially available, lugs, including the safety variety, forks, clevises or pin-type elements that pass through the main frame or the notches in it.

8. The Safety double connector of claim 6, characterised by the fact that the aforementioned thread needs to be moved in order to fold back the closing elements easily, which, by applying slight pressure, opens the spaces originated between the body of the frame and these spaces enabling an element to be inserted.

9. The Safety double connector of claim 8, characterised by the fact that the closing elements fold back easily by applying slight pressure to open the spaces between the body of the frame and the closing elements so as to enable an element to be inserted.

10. The Safety double connector of claim 9, characterised by the fact that the closing elements return to their initial position by means of a spring so as to close the space.

11. The Safety double connector of claim 9, characterised by the fact that the user must press the closing elements to fold them back when the element held inside the space is removed.

12. The Safety double connector of claim 1, characterised by the fact that its frame is made of a material suited to load on each section of the frame, such that the main section of the frame is variable, although it can also be made with a continuous section.
